(19) United States
(12) Patent Application Publication
(10) Pub. No.: US 2020/0158444 A1
(43) Pub. Date: May 21, 2020

(54) METHOD FOR MANUFACTURING VAPOR CHAMBER STRUCTURE AND VAPOR CHAMBER STRUCTURE

(71) Applicant: C.C. LATHE ENTERPRISE CO., LTD., New Taipei City (TW)

(72) Inventors: CHUI-HUNG CHIU, Taoyuan City (TW); KUAN-HSIN LIU, New Taipei City (TW)

(21) Appl. No.: 16/361,159

(22) Filed: Mar. 21, 2019

(30) Foreign Application Priority Data
Nov. 16, 2018 (TW) 107140796

(51) Int. Cl. F28D 15/04; F28D 15/02; B23P 15/26; B23K 20/10

(52) U.S. Cl. CPC F28D 15/046; B23K 20/10; B23P 15/26; F28D 15/0283

(57) ABSTRACT

A method for manufacturing a vapor chamber structure includes steps as follows. A first metal board and a second metal board are provided. A wick structure is disposed on at least one of the first metal board and the second metal board. A supporting structure is disposed in a receiving chamber cooperatively defined between the first metal board and the second metal board. The first metal board and the second metal board are assembled correspondingly, and are welded together by high-frequency ultrasonic welding in a frequency range of 20 kHz to 80 kHz. Finally, a vacuuming operation is performed and a working fluid is filled in the receiving chamber, and the receiving chamber is then sealed to form a hermetic sealing space within Therefore, the method does not need a sintering furnace process, and the combining process is quick to thereby increase production capacity and reduce costs.

### CROSS-REFERENCE TO RELATED PATENT APPLICATION

This application claims the benefit of priority to Taiwan Patent Application No. 107140796, filed on Nov. 16, 2018. The entire content of the above-identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for manufacturing a vapor chamber structure and a vapor chamber structure, and more particularly to a vapor chamber provided for heat transferring by the phase changes between the gas phase and the liquid phase.

### BACKGROUND OF THE DISCLOSURE

The development of electronic products in the technology industry is trending toward precision. Electronic devices such as integrated circuits and computers are designed with miniaturization in mind, which drastically increases the heat generated from such devices. The generated heat is increased even more drastically during operation of the electronic devices. Heat sinks or heat-dissipating devices are therefore developed correspondingly for various heat-generating electronic components, and are applied to dissipate heat, so that the electronic devices can operate normally under an allowable temperature. Vapor chambers and heat pipes are also conventional applications of heat-dissipating technologies. The principles of the vapor chamber and the heat pipe are the same, in which heat is transferred by phase changes between the gas phase and the liquid phase.

The vapor chamber has multiple characteristics, such as high heat-transferring capacity, less weight, simplified structure, and so on, which has led to their widespread application with heat-generating electronic components. By quickly transferring heat away from the heat-generating electronic components, heat accumulation in the heat-generating electronic components can be effectively reduced.

However, a diffusion welding process or a laser welding process is required for the production of the conventional vapor chamber. A vacuum hot pressing sintering furnace, also referred to as a sintering furnace, is needed for the diffusion welding process, and typically requires a sintering time of about 8 hours for production. Therefore, the production process is time-consuming and the product yield is low, which makes it hard to increase the production capacity and reduce costs.

### SUMMARY OF THE DISCLOSURE

In response to the above-referenced technical inadequacies, the present disclosure provides a method for manufacturing a vapor chamber structure and a vapor chamber structure, which does not need a sintering furnace process, so that the manufacturing time can be shortened and the product yield can be enhanced to improve productivity and reduce costs.

In one aspect, the present disclosure provides a method for manufacturing a vapor chamber structure including the following steps: providing a first metal board and a second metal board; disposing a wick structure on at least one of the first metal board and the second metal board, wherein the wick structure is disposed in a receiving chamber cooperatively defined between the first metal board and the second metal board; disposing a supporting structure between the first metal board and the second metal board; assembling the first metal board and the second metal board correspondingly; connecting a peripheral portion of the first metal board and a peripheral portion of the second metal board by ultrasonic welding in a frequency range of 20 kHz to 80 kHz; performing a vacuum process and injecting a working fluid into the receiving chamber; and sealing the receiving chamber as a hermetic sealing space.

In response to the above-referenced technical inadequacies, the present disclosure further provides a vapor chamber structure, which includes a first metal board, a second metal board, and a supporting structure. A wick structure is disposed on at least one of the first metal board and the second metal board. The wick structure is disposed in a receiving chamber cooperatively defined between the first metal board and the second metal board. The supporting structure is disposed between the first metal board and the second metal board. The first metal board and the second metal board are fittingly covered against each other in a complementary manner. A peripheral portion of the first metal board and a peripheral portion of the second metal board are welded and sealed by the ultrasonic welding in a frequency range of 20 kHz to 80 kHz. A working fluid is filled in the receiving chamber after a vacuum process, and the receiving chamber is then sealed to form a hermetic sealing space within.

In a preferable embodiment, the first metal board and the second metal board are board-shaped, the peripheral portion of the first metal board and the peripheral portion of the second metal board are roll-pressed, and are welded by the ultrasonic welding.

In a preferable embodiment, the wick structure is welded to at least one of the first metal board and the second metal board by the ultrasonic welding in a frequency range of 20 kHz to 80 kHz, and the supporting structure is connected with the first metal board and the second metal board by the ultrasonic welding in a frequency range of 20 kHz to 80 kHz, so that the supporting structure prevents a deformation when the vapor chamber structure is combined with a heat-generating electronic component.

In a preferable embodiment, the wick structure is roll-pressed, and is welded to at least one of the first metal board and the second metal board by the ultrasonic welding.

In a preferable embodiment, the supporting structure includes a plurality of supporting posts, the supporting posts are roll-pressed, and are welded to the first metal board and the second metal board by the ultrasonic welding.

Therefore, the present disclosure has advantages as follows. The first metal board and the second metal board, the wick structure and the supporting structure are connected by an ultrasonic welding process in the present disclosure. Therefore, the method of manufacturing a vapor chamber structure and vapor chamber structure of the present disclosure do not need a sintering furnace process. The production time can be shortened to within 20 to 60 seconds, from about 8 hours of the conventional sintering time, so that the producing time is shortened and the production yield is increased to increase the production capacity and reduce costs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a flowchart of a method for manufacturing a vapor chamber structure according to one embodiment of the present disclosure.

FIG. 2 is a perspective exploded view of the vapor chamber structure of the present disclosure.

FIG. 3 is a cross-sectional view of the vapor chamber structure of the present disclosure.

FIG. 4 is a perspective exploded view of the vapor chamber structure according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

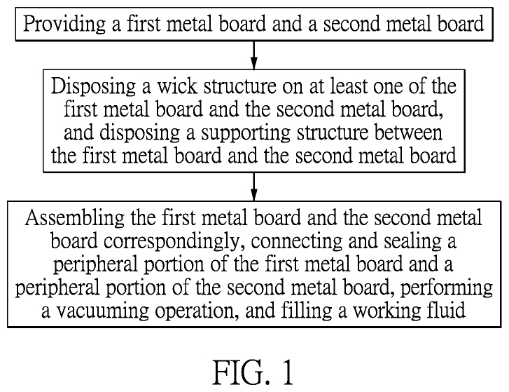

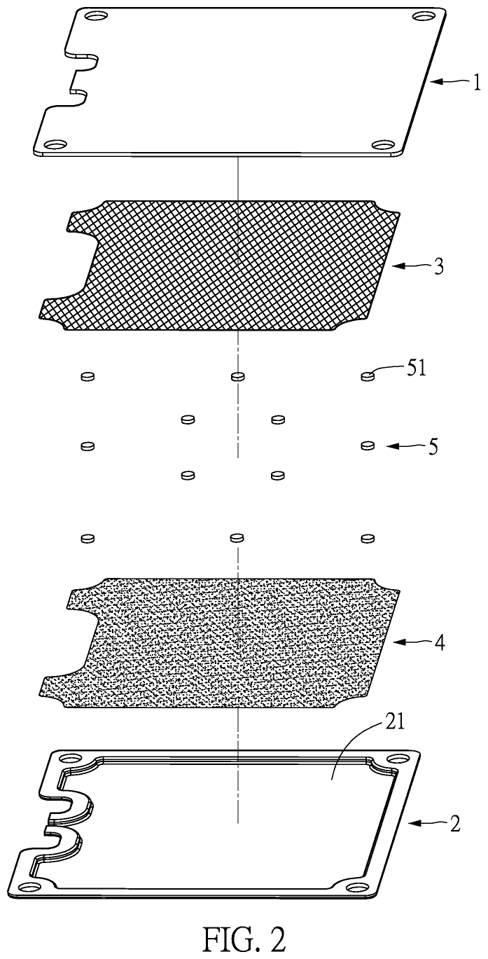

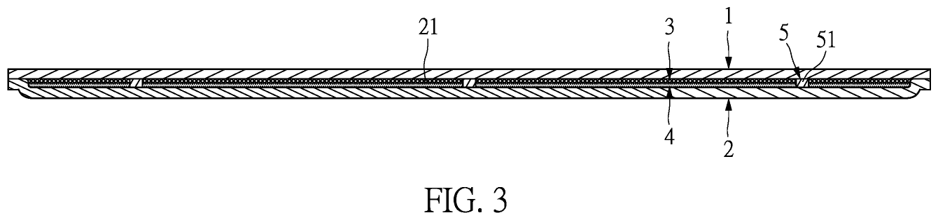

Reference is made to FIG. 1 to FIG. 3. An exemplary embodiment is illustrated according to the present disclosure.

The present disclosure provides a method for manufacturing a vapor chamber structure, which includes steps as follows.

Firstly, a first metal board 1 and a second metal board 2 are provided, which could be made of metal material with good conductivity, such as copper or aluminum . . . etc. The first metal board 1 and the second metal board 2 are board-shaped, which can be made by a stamping process. The sizes of the first metal board 1 and the second metal board 2 are not limited, and can be changed depending on particular requirements. The first metal board 1 and the second metal board 2 can be an upper casing and a lower casing of the vapor chamber structure, respectively. In this embodiment, the first metal board 1 is an upper casing, which is a flat board and can be welded with heat-dissipating fins, and the second metal board 2 is a lower casing, which can be formed with a concave chamber for contacting a heat source.

Then, a wick structure is disposed on at least one of the first metal board 1 and the second metal board 2. In this embodiment, both of the first metal board 1 and the second metal board 2 are provided with the wick structure. In other words, the wick structure 3 is disposed on one side of the first metal board 1, and the wick structure 4 is disposed on one side of the second metal board 2 opposite to the first metal board 1. The type and structure of the wick structures 3 and 4 are not limited, and can be one of the various wick structures that are currently available. The wick structures 3 and 4 are provided for absorbing and circulating working fluid by a capillary action. In this embodiment, the wick structure 3 can be a metal screen mesh, such as a copper screen mesh, and the wick structure 4 can be metal powder, such as copper powder. The wick structures 3 and 4 are disposed on two respective opposite sides of the first metal board 1 and the second metal board 2, so that the wick structures 3 and 4 can be arranged in a receiving chamber 21 cooperatively defined by the first metal board 1 and the second metal board 2. The wick structures 3 and 4 can be respectively welded to the first metal board 1 and the second metal board 2 by an ultrasonic welding technology. First, the wick structures 3 and 4 can be roll-pressed, and then can be respectively welded to the first metal board 1 and the second metal board 2 by the ultrasonic welding technology.

Next, a supporting structure 5 is disposed between the first metal board 1 and the second metal board 2. The type and structure of the supporting structure 5 are not limited. The supporting structure 5 can be one of various available supporting structures, and is mainly used to prevent a deformation when the vapor chamber structure is combined and contacted with an electronic heating element. Therefore, the first metal board 1 and the second metal board 2 can be prevented from deformation and collapse, and the vapor chamber structure has better structural strength. Since the vapor chamber structure of the present disclosure does not need a sintering process of high temperature, it will not be deformed in the manufacturing process. In this embodiment, the supporting structure 5 includes a plurality of supporting posts 51. The supporting posts 51 can be metal posts, such as metal posts, which can be welded to the first metal board 1 and the second metal board 2 by the ultrasonic welding technology. In other words, two ends of the supporting post 51 are contacted with the first metal board 1 and the second metal board 2, respectively. The supporting posts 51 can be pressed by a rolling manner, and are respectively welded to the first metal board 1 and the second metal board 2 by the ultrasonic welding technology.

After that, the first metal board 1 and the second metal board 2 are assembled by covering each other in a matching manner. A peripheral portion of the first metal board 1 and a peripheral portion of the second metal board 2 are welded and sealed by the ultrasonic welding technology. Finally, a vacuum operation is processed and a working fluid is filled in the receiving chamber 21 prior to final hermetic sealing of the receiving chamber 21 to form a hermetic sealing space within. The working fluid is a liquid working fluid with a lower boiling point, such as pure water, methanol, refrigerant, acetone, or ammonia, which are generally chosen as the two-phase vaporizable liquid for quickly and uniformly transporting thermal energy. The peripheral portion of the first metal board 1 and the peripheral portion of the second metal board 2 can be roll-pressed, and then can be welded by ultrasonic acoustic vibrations.

According to the aforesaid method, the present disclosure further provides a vapor chamber structure, which includes a first metal board 1, a second metal board 2 and a supporting structure 5. A wick structure is disposed on at least one of the first metal board 1 and the second metal board 2. In this embodiment, one side of the first metal board 1 is disposed with the wick structure 3 and one side of the second metal board 2 is disposed with the wick structure 4 opposite to the first metal board 1. The wick structure 3 can be metal screen mesh, such as copper screen mesh, and the wick structure 4 can be metal powder, such as copper powder. The wick structures 3 and 4 are arranged in a receiving chamber 21 cooperatively formed by the first metal board 1 and the second metal board 2. The wick structures 3 and 4 can be respectively attached to the first metal board 1 and the second metal board 2 by ultrasonic welding.

In addition, a supporting structure 5 is disposed between the first metal board 1 and the second metal board 2. In this embodiment, the supporting structure 5 includes a plurality of supporting posts 51. The supporting posts 51 can be metal posts, such as copper posts. The supporting posts 51 can be connected to the first metal board 1 and the second metal board 2 by high-frequency ultrasonic welding.

The first metal board 1 and the second metal board 2 are assembled correspondingly, that is, both are covered against each other in a complementary manner A peripheral portion of the first metal board 1 and a peripheral portion of the second metal board 2 are connected. Then, a vacuuming operation is performed and a working fluid is filled into the receiving chamber 21 prior to final hermetic sealing of the receiving chamber 21 to form a hermetic sealing space within. Therefore, a vapor chamber structure is completed. Since the vapor chamber structure of the present disclosure has been described in the above embodiment, it will not be reiterated herein for the sake of brevity.

According to the present disclosure, the working fluid in the vapor chamber structure absorbs heat and boils to the gas phase (i.e., vapor), and quickly spreads across the whole receiving chamber 21 at an evaporation section. Then, the working fluid releases heat and is condensed to return in a liquid phase at a condensation section. The liquid working fluid can pass through the wick structures 3, 4 and return to the evaporation section, so that a circulation of quick thermal transportation can be performed.

In the aforesaid ultrasonic welding process, the high-frequency ultrasonic welding can be in a frequency range of 20 kHz to 80 kHz, such as 20 kHz, 30 kHz, 40 kHz, 50 kHz, 60 kHz, 70 kHz or 80 kHz. The ultrasonic welding is an industrial technique whereby high-frequency ultrasonic mechanical vibrations are locally applied to metal workpieces of the same or different kinds being held together with pressure. During ultrasonically welding the metal workpieces, the metal workpieces are only processed under a static pressure for a period of time with mechanical energy that is transformed into an internal energy, a deformation energy, and a limited rise of temperature, and does not require an electric current or high-temperature heat to be transferred to the metal workpieces.

### Second Embodiment

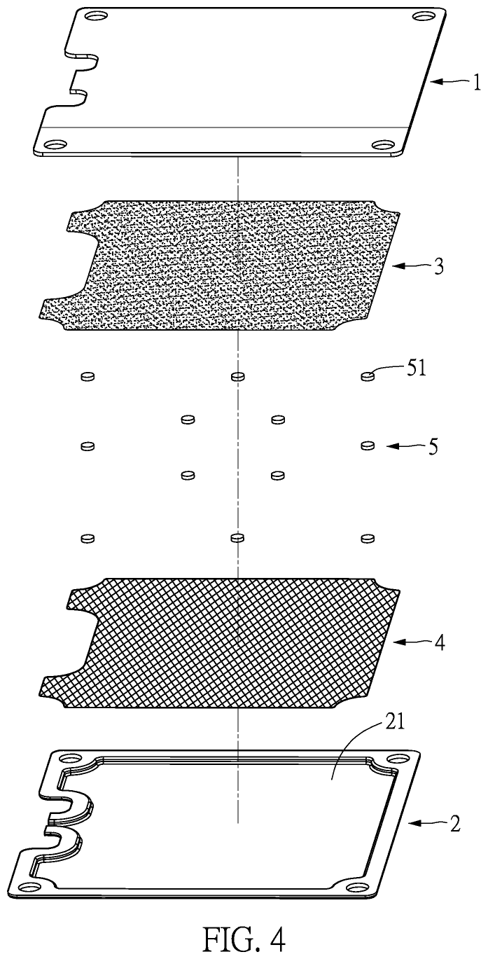

Reference is made to FIG. 4, which is a perspective exploded view of the vapor chamber structure according to a second embodiment of the present disclosure. In this embodiment, the wick structure 3 can be metal powder, such as copper powder, and the wick structure 4 can be metal screen mesh, such as copper screen mesh. The wick structures 3 and 4 are disposed on two opposite sides of the first metal board 1 and the second metal board 2, respectively.

In conclusion, the characteristics and effect of the present disclosure are that, the first metal board 1 and the second metal board 2 are sealed tight with each other by an ultrasonic welding process. The wick structures 3, 4 and the supporting structure 5 can also be welded to the first metal board 1 and second metal board 2 by ultrasonic welding. Therefore, the present disclosure provides a manufacturing method of the vapor chamber structure, which does not need a sintering furnace or a sintering process, so that the production time can be shortened from the 8 hours of a conventional sintering production time to 20-60 seconds. Therefore, the production time is shortened, and the yield is improved, so that productivity can be increased and the costs can be reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a vapor chamber structure, comprising steps of:
providing a first metal board and a second metal board;
disposing a wick structure on at least one of the first metal board and the second metal board, wherein the wick structure is disposed in a receiving chamber cooperatively defined between the first metal board and the second metal board;
disposing a supporting structure between the first metal board and the second metal board;
assembling the first metal board and the second metal board correspondingly;
connecting a peripheral portion of the first metal board and a peripheral portion of the second metal board by ultrasonic welding in a frequency range of 20 kHz to 80 kHz;
performing a vacuum process and injecting a working fluid into the receiving chamber; and
sealing the receiving chamber as a hermetic sealing space.

2. The method according to claim 1, wherein the first metal board and the second metal board are board-shaped, the peripheral portion of the first metal board and the peripheral portion of the second metal board are pressed in a rolling manner, and are welded by the ultrasonic welding.

3. The method according to claim 1, wherein the wick structure is welded to at least one of the first metal board and the second metal board by the ultrasonic welding in a frequency range of 20 kHz to 80 kHz, and the supporting structure is connected with the first metal board and the second metal board by the ultrasonic welding in a frequency range of 20 kHz to 80 kHz, so that the supporting structure prevents a deformation when the vapor chamber structure is combined with a heat-generating electronic component.

4. The method according to claim 3, wherein the wick structure is roll-pressed and is welded to at least one of the first metal board and the second metal board by the ultrasonic welding.

5. The method according to claim 3, wherein the supporting structure includes a plurality of supporting posts, the supporting posts are roll-pressed and are respectively welded to the first metal board and the second metal board by the ultrasonic welding.

6. A vapor chamber structure, comprising:
a first metal board;
a second metal board;
a wick structure disposed on at least one of the first metal board and the second metal board, wherein the wick structure is disposed in a receiving chamber cooperatively defined between the first metal board and the second metal board; and
a supporting structure disposed between the first metal board and the second metal board;
wherein the first metal board and the second metal board are fittingly covered against each other in a complementary manner, a peripheral portion of the first metal board and a peripheral portion of the second metal board are welded and sealed by ultrasonic welding in a frequency range of 20 kHz to 80 kHz, and
wherein a working fluid is filled in the receiving chamber after a vacuum operation is processed, and the receiving chamber is then sealed to form a hermetic sealing space within.

7. The vapor chamber structure according to claim 6, wherein the first metal board and the second metal board are board-shaped, the peripheral portion of the first metal board and the peripheral portion of the second metal board are roll-pressed and are welded by the ultrasonic welding.

8. The vapor chamber structure according to claim 6, wherein the wick structure is welded to at least one of the first metal board and the second metal board by an ultrasonic welding in a frequency range of 20 kHz to 80 kHz, the supporting structure is welded to the first metal board and the second metal board by the ultrasonic welding in a frequency range of 20 kHz to 80 kHz, so that the supporting structure prevents a deformation when the vapor chamber structure is combined with a heat-generating electronic component.

9. The vapor chamber structure according to claim 8, wherein the wick structure is roll-pressed and is welded to at least one of the first metal board and the second metal board by ultrasonic welding.

10. The vapor chamber structure according to claim 8, wherein the supporting structure includes a plurality of supporting posts, and the supporting posts are roll-pressed and respectively welded to the first metal board and the second metal board by the ultrasonic welding.
